(19) United States
(12) Patent Application Publication
(10) Pub. No.: US 2008/0195836 A1
(43) Pub. Date: Aug. 14, 2008

(54) Method or Apparatus for Storing Data in a Computer System

(75) Inventors: Kishore Kumar Muppirala, Karnataka (IN); Bhanu Gollapudi Venkata Prakash, Karnataka (IN); Phalachandra H. Lakshmikanthaiah, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/884,792

(22) PCT Filed: Feb. 23, 2005
(86) PCT No.: PCT/IN2005/000062

§ 371 Date: Oct. 19, 2007

(51) Int. Cl. G06F 12/00

(52) U.S. Cl. 711/173; 711/E12.001

(57) ABSTRACT

A method and apparatus are disclosed for storing data in a computer system 101 which data from a first portion of a system memory 117 is stored in a secondary memory 105; the first portion of the system memory 117 is allocated for subsequent use by an operating system (OS); the OS is rebooted and run using the allocated memory; and data from a remaining portion of the system memory 117 is stored in the secondary memory 105.

### FIELD OF INVENTION

The present invention relates to a method or apparatus for storing data in a computer system.

### BACKGROUND OF THE INVENTION

In computer systems, recovery from application software failures can be achieved relatively easily by restarting the application. If the application is large, application check pointing can help reduce the application recovery times. Recovery from operating system (OS) failures takes longer compared to application software failure, as an OS failure requires a reboot operation. Prior to restarting an OS after a failure, a copy of the state or kernel image of the failed OS along with its associated data is dumped or saved-off from system memory to a pre-designated area of secondary storage associated with the computer system. The secondary storage may be a single disk or a group of disks or a partition within a disk. The dumped data is used in the diagnosis of the OS failure. The computer system cannot run application software until the new OS completes its reboot process.

Some computer systems include a mechanism which speeds up the dumping process by only dumping the elements from the old OS that are relevant for subsequent dump analysis. Other techniques to reduce the amount of time taken to dump the failed OS use additional memory to first save specific parts of relevant memory. One drawback of known systems is that the dumping process delays the rebooting of the OS.

It is an object of the invention to reduce the time taken to reboot an OS after a failure while still enabling the dumping of relevant data from the system memory.

It is an object of the present invention to provide a method or apparatus for storing data in a computer system, which avoids some of the above disadvantages or at least provides a useful alternative.

### SUMMARY OF THE INVENTION

Some embodiments of the invention provide a method for storing data in a computer system, the method comprising the steps of:

a) storing data from a first portion of a system memory in a secondary memory;
b) allocating the first portion of the system memory for subsequent use by an operating system (OS);
c) rebooting and running the OS using the allocated memory; and
d) storing data from a remaining portion of the system memory in the secondary memory.

The running of the OS and step d) may be carried out concurrently. Step a) may carried out by firmware prior to steps b) to d). Step d) may carried out by one or more processing threads of the OS. Each thread may be allocated a part of the remaining portion of system memory and when the data from the part is stored in the secondary storage, the thread quits. Alternatively, step d) may be carried out under the control of firmware.

The computer system may comprises a plurality of CPUs and the processing of step d) may be allocated between the plurality of CPUs. Step d) may be carried out by a subset of the plurality of CPUs. Each CPU may be allocated a part of the remaining portion of system memory and when the data from the part is stored in the secondary storage, each of the CPUs reverts to providing the OS. The method may further comprises the step of: e) allocating memory freed in step d) for use by the OS. In step d) the storing may be carried out in predetermined blocks of the memory and in step e) as each the block is freed it may be allocated for use by the OS.

In step a) the data may be kernel data which is swapped out of the dump image. In step a) the first portion of the system memory may be the minimum amount required to run the OS. In step a) the first portion may comprise up to 1% of the system memory.

Step a) may be carried out as part of a reboot of the computer system. The reboot may be carried out in response to an OS failure. The reboot operation may be arranged to operate automatically in response to the OS failure. Alternatively, step a) may be carried out as part of a back up operation for the system memory.

Other embodiments of the invention provide apparatus for storing data in a computer system, the apparatus comprising:

processing means operable to store data from a first portion of a system memory in a secondary memory;
a memory management system operable to allocate the first portion of the system memory for subsequent use by an operating system (OS); and
the processing means being further operable to reboot the OS using the allocated memory and to store data from a remaining portion of the system memory in the secondary storage.

Further embodiments of the invention provide a method of dumping data from a multiprocessor computer system memory during an OS reboot operation comprising the steps of:

a) freeing a first portion of a computer system memory by saving data to a secondary storage area;
b) restarting the OS using the freed system memory and a first of the computer system CPUs;
c) instructing a second of the CPUs to save the remaining data from the system memory to the secondary storage area; and
d) reallocating the second CPU for use by the OS when the saving of the remaining data is complete.

Further embodiments of the invention provide a method of dumping data from a computer system memory during an OS reboot operation comprising the steps of:

a) freeing a first portion of a computer system memory by saving data to a secondary storage area;
b) restarting the OS using the freed system memory;
c) initiating a processing thread for saving the remaining data from the system memory to the secondary storage area; and
d) terminating the thread when the storage of the remaining data is complete.

Further embodiments of the invention provide apparatus for rebooting a computer system after an OS failure, the apparatus comprising:

means for storing data from a first portion of a system memory in a secondary memory area;
means for allocating the first portion of the system memory for subsequent use by the operating system (OS);
means for rebooting the OS using the allocated memory; and
means for concurrently storing data from a remaining portion of the system memory in the secondary storage area and providing the OS.

Further embodiments of the invention provide a computer processor for a computer system operable in response to an operating system (OS) failure to:

a) store data from a first portion of a system memory in a secondary memory area;
b) allocate the first portion of the system memory for subsequent use in rebooting the operating system (OS);
c) reboot the OS using the allocated memory; and
d) store data from a remaining portion of the system memory in the secondary storage area while also running the OS.

Further embodiments of the invention provide a computer program or group of programs arranged to enable a computer or group of computers to carry out a method for storing data in a computer system, the method comprising the steps of:

a) storing data from a first portion of a system memory in a secondary memory;
b) allocating the first portion of the system memory for subsequent use by an operating system (OS);
c) rebooting and running the OS using the allocated memory; and
d) storing data from a remaining portion of the system memory in the secondary storage.

Further embodiments of the invention provide a computer program or group of programs arranged to enable a computer or group of computers to provide apparatus for storing data in a computer system, the apparatus comprising:

processing means operable to store data from a first portion of a system memory in a secondary memory;
a memory management system operable to allocate the first portion of the system memory for subsequent use by an operating system (OS); and
the processing means being further operable to reboot and run the OS using the allocated memory and to store data from a remaining portion of the system memory in the secondary memory.

### BRIEF DESCRIPTION OF THE DRAWINGS

Embodiments of the invention will now be described, by way of example only, with reference to the accompanying drawings in which:

FIG. 1 is a schematic illustration of a computer system;

FIGS. 2a & 2b are schematic illustrations of the reboot process of the computer system of FIG. 1;

FIG. 3 is a flow chart illustrating the reboot process according to an embodiment of the invention; and

FIG. 4 is a flowchart illustrating the reboot process according to another embodiment of the invention.

### DETAILED DESCRIPTION OF PREFERRED EMBODIMENTS OF THE INVENTION

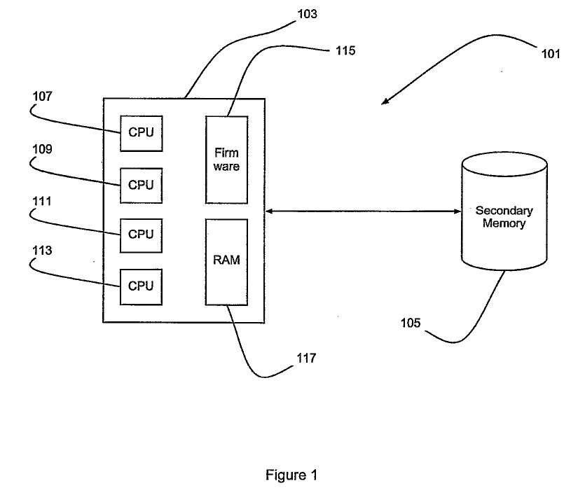

With reference to FIG. 1, a computer system 101 comprises a computer 103 connected to a secondary memory in the form of an external disk drive 105. The computer 103 is a multiple processor system having four central processing units (CPUs) 107, 109, 111, 113, firmware 115 and system memory in the form of random access memory (RAM) 117. The RAM 117 provides 100 gigabytes (GB) of system memory capacity. The firmware 115 is in the form of software written onto read-only memory (ROM). The firmware includes the basic input/output system (BIOS), which is software arranged to carry out the basic functions of the computer system such as controlling a keyboard, display screen, disk drives and serial communications.

The BIOS controls the initial start-up process of the computer system 101, during which the CPUs 107, 109, 111, 113 are initialized. Subsequently, a Unix™ operating system (OS) stored on the secondary memory 105 is loaded into the RAM 117 for operation. If a fault occurs during the operation of the OS then the OS must be restarted. The restart or reboot procedure is similar to the initial start-up of the computer system but with the addition step of carrying out a system memory dump before the OS itself can be restarted. The memory dump involves saving data relating to the old, failed OS for later analysis. This saved data is commonly referred to as the old or dead system memory (OSM or DSM), a kernel image or an OS image.

The dumping process is initiated by software stored in the firmware and the process can be selective or non-selective. A selective dumping algorithm selects and saves only pages of system memory that contain kernel relevant data. A simpler non-selective dumping algorithm saves the whole system memory irrespective of relevance of the data for dump analysis. Non-selective dumping is also referred to as a full dump. The present embodiment uses a non-selective dumping algorithm.

The firmware 115 is arranged to carry out the reboot process in two phases. In the first phase, a first portion of the data from the OSM is saved to the disk drive 105. The amount of the first portion is arranged to free sufficient system memory for use by the new OS to enable it to boot-up and provide basic services to applications in the computer system 101. In addition, the new OS initially uses only two of the CPUs 107, 109. The size of this first portion of memory and the number of CPUs initially assigned to the new OS is determined based on the number of CPUs required for the new OS to run effectively taking into account the anticipated application program load.

In the second phase, while the new OS is booting-up and running using two of the four CPUs 107, 109, the remaining CPUs 111, 113 start to save the remaining OSM to the disk drive 105. The system memory freed by the CPUs 111, 113 is progressively made available to the new OS thereby gradually increasing the size of the current system memory. Similarly, once a given CPU has completed the dumping of the data from its allocated part of the OSM, the CPU is joined to the resources of the new OS. Once all of the OSM has been dumped, the new OS can use all of the CPUs 107, 109, 111, 113.

This two phase approach reduces the downtime of the computer system compared to a conventional dumping system. Assuming that the OS boot time does not change significantly in either case, the savings accomplished with the present approach are:

(dump time for OSM remainder)/(dump time for total system memory)

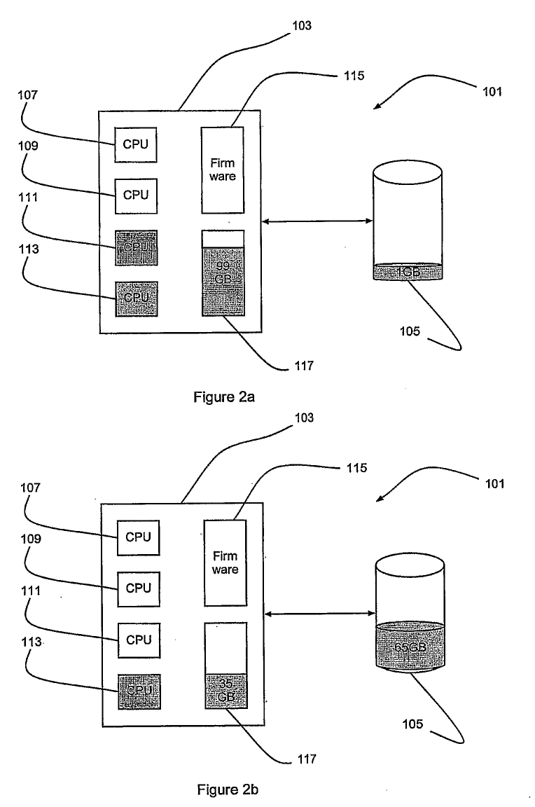

FIG. 2a is a view of the computer system 101 at the start of the second phase of a system memory dump as described above where 1 gigabyte (GB) (1%) of the old system memory has been dumped to the disk 105 (shown shaded). The first two CPUs 109, 111 (shown not shaded) are loading the OS from the disk 105 and restarting the OS using the 1 GB of the RAM 117 (shown not shaded) freed during the first phase of the reboot process as described above. The third and fourth CPUs 111, 113 (shown shaded) are occupied in dumping the remainder of the old system data (shown shaded) from the RAM 117 to the disk 105. Each of the CPUs 111, 113 are allocated a 49.5 GB portion of the data from the old system memory to dump to the disk 105.

When either of the third or fourth CPUs 111, 113 have completed the dumping of their allocated portions of the old system memory data they join the first and second CPUs 107, 109 in providing the OS. FIG. 2b shows the computer system 101 when the third CPU 111 (now not shaded) has completed its dump allocation and is now providing the OS. The fourth CPU 113 is still in the process of dumping its allocation having completed 14.5 GB. As a result, the system memory 117 still contains 35 GB of OSM and the disk has 65 GB of dumped data. Once the fourth CPU 113 has completed its allocated dump, all four processors will revert to providing the OS.

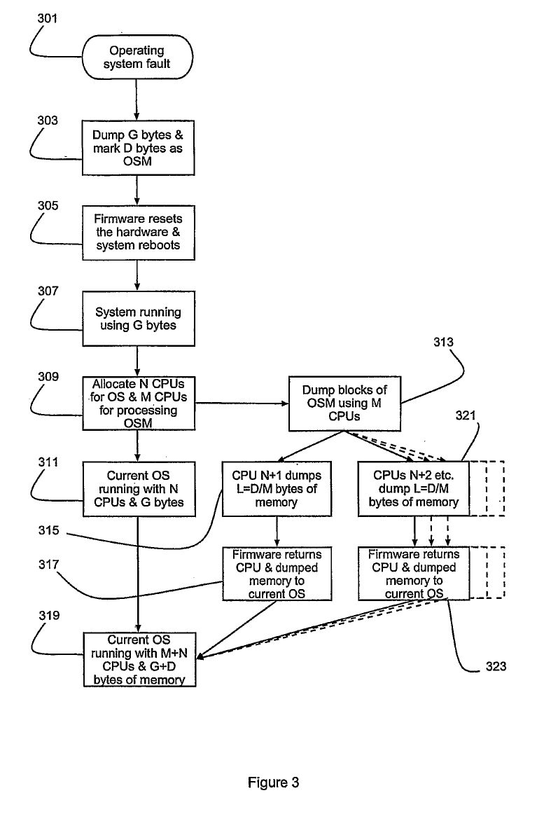

The processing carried out by the firmware 115 and the CPUs 107, 109, 111, 113 for restarting the computer system 101 after an OS fault will now be described with reference to the flow chart of FIG. 3. At step 301 a fatal OS fault is detected, the OS ceases operation and processing moves to step 303. At step 303, the first portion G bytes of the system memory for the failed OS is saved to disk and the remaining D bytes are designated as OSM and processing moves to step 305. At a step 305 the firmware resets the CPUs and other hardware and initiates the rebooting process. The reset is non-destructive in that the contents of the system memory are not reset or erased. At step 307 the OS is running using the G bytes of memory that were freed in step 303 and at step 309 the firmware allocates N CPUs to run the OS and the remaining M CPUs to complete the OSM dumping process. The processing is then split between the CPUs running the OS which continue to step 311 and the CPUs completing the dump operation which continue to step 313.

At step 313, the firmware initiates the dumping process by allocating blocks of the OSM to each of the M CPUs. For the first CPU, processing then moves to step 315 where the CPU dumps L bytes (where L=D/M) of OSM to the disk and once this is complete processing moves to step 317 where the firmware returns the CPU and the freed memory for use by the new OS. For the remaining M−1 CPUs, the processing of steps 315 and 317 is duplicated as shown by steps 321 and 323 for each remaining CPU (indicated by the dotted process step outlines).

At step 311 the N CPUs provide the OS using the G bytes of memory plus the memory freed as each of the M CPUs completes portions of its allocated dumping. In addition, as each of the M CPUs completes its allocated dumping, those CPUs join the N CPUs in running the OS. Thus at step 319, the number of CPUs running the new OS converges to M+N and the new system memory increases to G+D bytes.

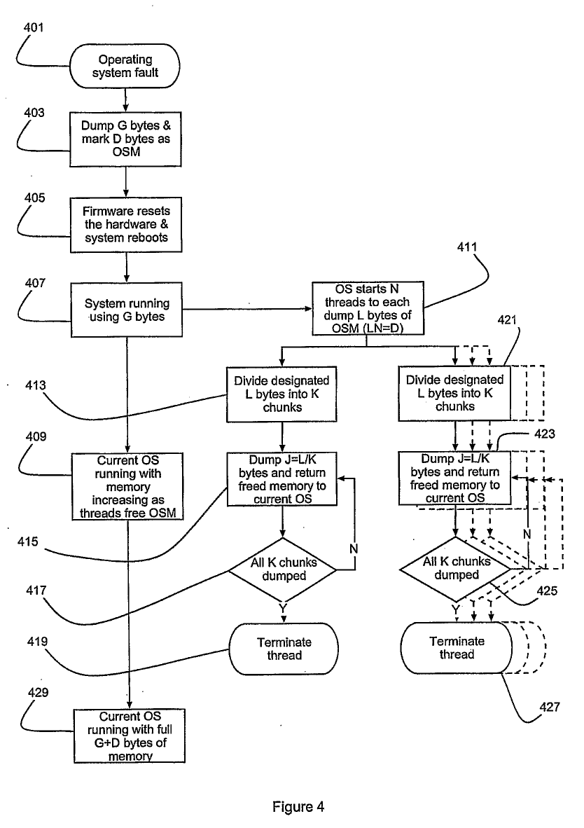

In an alternative embodiment, the computer system is as described above in FIG. 1 but has a single CPU and an OS capable of multiple processing threads. The dumping process carried out by this system will now be described with reference to FIG. 4 in which at step 401 a fatal OS fault is detected, the OS ceases operation and processing moves to step 403. At step 403, the first portion G bytes of the system memory for the failed OS is saved to disk and the remaining D bytes are designated as read only OSM and processing moves to step 405. At a step 405 the firmware resets the CPU and other hardware and initiates the rebooting process. The reset is non-destructive in that the contents of the system memory are not reset or erased. At step 407 the OS is running using the G bytes of memory that were freed in step 403. The OS then initiates a number (N) of processing threads and moves to step 409 and provides the OS using the G bytes of memory. The N threads move to step 411 where each thread is allocated L bytes (where L=D/N) of the OSM for dumping. The number of threads to use for this purpose is computed based on the I/O bandwidth available to new OS and the amount of OSM to dump.

At step 413, the first thread divides its allocated L bytes of OSM into K chunks and processing moves to step 415. At step 415 J bytes (where J=L/K) of the allocated OSM is dumped and the pages freed are marked as normal by the memory management subsystem of the OS making that memory available to the OS as well as applications. Processing then moves to step 417 where a check is carried out to determine if all K chunks have been dumped and if not processing returns to step 415 as described above. If, however, all K chunks have been dumped then at step 419, the thread is terminated.

Each of the other N threads carry out the same processing steps for their allocated L bytes of OSM as shown in steps 421, 423, 425 and 427 (the steps shown in dotted lines each representing the remaining processing threads). As each thread progressively returns freed memory to the OS in step 409, the memory available to the OS steadily increases to full capacity at step 429 when all threads carrying out the dumping process have terminated.

In a further embodiment the computer system has a single CPU and a multithreading OS and instead of incrementally adding memory in chunks as described in step 415 above, the OS waits for the dumping threads to complete the whole dump and then accepts the complete OSM as normal useable memory.

In a yet further embodiment, the computer system is a multiple CPU system as described above for FIG. 1 which, in addition, has an OS which is capable of multithreaded processing.

In another embodiment, the system administrator can configure the number of threads or number of CPUs allocated to the dumping process depending on the anticipated application load on the system. This step can be carried out as a manual step in the boot-up procedure.

As described in the embodiments above, only the first portion or pages of the OSM need to be examined initially. These first pages are saved to the dump device such as a disk and the computer system is immediately allowed to transfer control back to firmware and the process of booting the new OS can start. In a computer system with a large system memory, only a small portion of the entire system memory is needed for those first pages. The larger the system memory, the shorter the system down time and the greater the system availability. In other words, the restart can begin before the dumping process is complete and the OS can run effectively in parallel with the remainder of the boot operation. Furthermore, the arrangements described above can be used with either selective or non-selective dumping algorithms in either the first and/or the second phase of the process.

In the embodiments above, in the first phase, the first portion of the data from the OSM comprises 1% of the system memory. This is a typical arrangement for a computer system with a large system memory of tens of gigabytes. The first portion is determined as the amount of memory required for the kernel/OS to load and create the necessary data structures to be able to detect and configure all I/O devices and to execute multiple kernel threads that perform the dumping task. In the above embodiments, where the firmware performs the dumping task, the kernel will not require memory to execute dumping threads, however, it may have to provide additional memory that will be incrementally added into the system as each of the firmware owned CPUs perform their dumping task and make the memory available for the OS's use. For a given system configuration, based on the data available with the OS before it failed, the size of the first portion of OSM can be calculated at set-up and may include a safety margin to ensure that the next OS does not fail to boot-up owing to any minor oversight in the calculation by the current instance of the OS. In computer systems with smaller system memories, the size of the first portion will be a correspondingly larger percentage of the total memory.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network, floppy disc, CD-ROM or magnetic tape so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1.-33. (canceled)

34. A method for storing data in a computer system, the method comprising the steps of:
a) storing data from a first portion of a system memory in a secondary memory;
b) allocating said first portion of said system memory for subsequent use by an operating system (OS);
c) rebooting and running said OS using said allocated memory; and
d) storing data from a remaining portion of said system memory in said secondary memory.

35. A method according to claim 34 in which said running of said OS and step d) are carried out concurrently.

36. A method according to claim 34 in which step a) is carried out by firmware prior to steps b) to d).

37. A method according to claim 34 in which step d) is carried out under the control of firmware.

38. A method according to claim 36 in which step d) is carried out by one or more processing threads of said OS.

39. A method according to claim 38 in which each thread is allocated a part of said remaining portion of system memory and when said data from said part is stored in said secondary storage, said thread quits.

40. A method according to claim 34 in which the computer system comprises a plurality of CPUs and the processing of step d) is allocated between said plurality of CPUs.

41. A method according to claim 40 in which step d) is carried out by a subset of said plurality of CPUs.

42. A method according to claim 40 in which each CPU is allocated a part of said remaining portion of system memory and when said data from said part is stored in said secondary storage, each said CPU reverts to providing said OS.

43. A method according to claim 34 further comprising the step of:
e) allocating memory freed in step d) for use by said OS.

44. A method according to claim 43 in which in step d) said storing is carried out in predetermined blocks of said memory and in step e) as each said block is freed it is allocated for use by said OS.

45. A method according to claim 34 in which in step a) the data is kernel data which is swapped out of the dump image.

46. A method according to claim 34 in which in step a) said first portion of said system memory is the minimum amount required to run the OS.

47. A method according to claim 34 in which in step a) said first portion comprises up to 1% of said system memory.

48. A method according to claim 34 in which step a) is carried out as part of a reboot of the computer system.

49. A method according to claim 48 in which said reboot is carried out in response to an OS failure.

50. A method according to claim 49 in which said reboot operation is arranged to operate automatically in response to said OS failure.

51. A method according to claim 34 in which step a) is carried out as part of a back up operation for said system memory.

52. Apparatus for storing data in a computer system, the apparatus comprising:
processing means operable to store data from a first portion of a system memory in a secondary memory;
a memory management system operable to allocate said first portion of said system memory for subsequent use by an operating system (OS); and
said processing means being further operable to reboot and run said OS using said allocated memory and to store data from a remaining portion of said system memory in said secondary memory.

53. Apparatus according to claim 52 in which said processing means is further operable to run said OS concurrently with said storage of said data from said remaining portion of said system memory.

54. Apparatus according to claim 52 in which storage of data from the first portion of said system memory is carried out by firmware prior to said rebooting of said OS.

55. Apparatus according to claim 52 in which the storage of said data from said remaining portion of said system memory is carried out under the control of firmware.

56. Apparatus according to claim 54 in which the storage of said data from said remaining portion of said system memory is carried out by one or more processing threads of the operating system (OS).

57. Apparatus according to claim 56 in which each thread is allocated a part of said remaining portion of system memory and when said data from said part is stored in said secondary storage, said thread quits.

58. Apparatus according to claim 52 in which the computer system comprises a plurality of CPUs and the storage of said data from said remaining portion of said system memory is allocated between said plurality of CPUs.

59. Apparatus according to claim 58 in which the storage of said data from said remaining portion of said system memory is allocated to a subset of said plurality of CPUs.

60. Apparatus according to claim 59 in which each CPU is allocated a part of said remaining portion of system memory and when said data from said part is stored in said secondary storage, each said CPU reverts to providing said OS.

61. Apparatus according to claim 52 in which the memory management system is further operable to allocate said memory freed by said storage of said data from said remaining portion of said system memory is allocated for use by said OS.

62. Apparatus according to claim 61 in which said storage of said data from said remaining portion of said system memory is carried out in predetermined blocks of said memory and as each said block is freed it is allocated for use by said OS.

63. Apparatus according to claim 52 in which said first portion of said system memory is the minimum amount required to run the OS.

64. Apparatus according to claim 52 in which said first portion comprises up to 1% of said system memory.

65. A method of dumping data from a multiprocessor computer system memory during an OS reboot operation comprising the steps of:
a) freeing a first portion of a computer system memory by saving data to a secondary storage area;
b) restarting the OS using said freed system memory and a first of said computer system CPUs;
c) instructing a second of said CPUs to save the remaining data from said system memory to said secondary storage area; and
d) reallocating said second CPU for use by said OS when said saving of said remaining data is complete.

66. A method of dumping data from a computer system memory during an OS reboot operation comprising the steps of:
a) freeing a first portion of a computer system memory by saving data to a secondary storage area;
b) restarting the OS using said freed system memory;
c) initiating a processing thread for saving the remaining data from said system memory to said secondary storage area; and
d) terminating said thread when said storage of said remaining data is complete.

67. Apparatus for rebooting a computer system after an OS failure, the apparatus comprising:
means for storing data from a first portion of a system memory in a secondary memory area;
means for allocating said first portion of said system memory for subsequent use by said operating system (OS);
means for rebooting said OS using said allocated memory; and
means for concurrently storing data from a remaining portion of said system memory in said secondary storage area and providing said OS.

68. A computer processor for a computer system operable in response to an operating system (OS) failure to:
a) store data from a first portion of a system memory in a secondary memory area;
b) allocate said first portion of said system memory for subsequent use in rebooting said operating system (OS);
c) reboot said OS using said allocated memory; and
d) store data from a remaining portion of said system memory in said secondary storage area while also running said OS.

69. A computer program or group of computer programs arranged to enable a computer or group of computers to carry out a method for storing data in a computer system, the method comprising the steps of:
a) storing data from a first portion of a system memory in a secondary memory;
b) allocating said first portion of said system memory for subsequent use by an operating system (OS);
c) rebooting and running said OS using said allocated memory; and
d) storing data from a remaining portion of said system memory in said secondary memory.

70. A computer program or group of computer programs arranged to enable a computer or group of computers to provide apparatus for storing data in a computer system, the apparatus comprising:
processing means operable to store data from a first portion of a system memory in a secondary memory;
a memory management system operable to allocate said first portion of said system memory for subsequent use by an operating system (OS); and
said processing means being further operable to reboot and run said OS using said allocated memory and to store data from a remaining portion of said system memory in said secondary memory.
